(19) United States
(12) Patent Application Publication
(10) Pub. No.: US 2016/0185573 A1
(43) Pub. Date: Jun. 30, 2016

(54) ESCALATOR SKIRT LIGHTING

(71) Applicants: Charles Anthony MULLINS, Locust Grove, GA (US); Daniel Aaron Richardson, Gulf Breeze, FL (US)

(72) Inventors: Charles Anthony MULLINS, Locust Grove, GA (US); Daniel Aaron Richardson, Gulf Breeze, FL (US)

(21) Appl. No.: 14/660,078

(22) Filed: Mar. 17, 2015

Related U.S. Application Data
(60) Provisional application No. 62/098,771, filed on Dec. 31, 2014.

(51) Int. Cl. B66B 23/22

(52) U.S. Cl. CPC B66B 23/225

(57) ABSTRACT

A lighting system for attachment to a human conveyor, such as to an escalator or moving sidewalk, comprises an elongate body having two or more grooves extending longitudinally along a substantial length of the elongate body, wherein the grooves contain an elongate rope light and an elongate brush, respectively. The rope light can be placed in the upper groove or in the lower groove. Alternatively, rope lights can be placed in both grooves and the brush eliminated.

### CROSS-REFERENCE TO RELATED APPLICATION

This application claims the priority benefit of U.S. Provisional Patent Application 62/098,771, filed Dec. 31, 2014, which is hereby incorporated herein by reference.

### BACKGROUND

Currently, escalators are equipped with numerous safety features. Among these are green lights at the landing areas at the top and bottom, yellow or other colors of paint outlining individual steps, skirt brushes to provide the rider with a tactile sensation if he or she gets too close to the edge, emergency stop buttons, handrails, safety signage, combs at landing areas to prevent hands or other items from getting caught, and deck guards to prevent people or items from becoming stuck between the escalator and a wall.

However, despite the existence of these safety features, numerous accidents occur on escalators each year. The US Consumer Product Safety Commission estimates that about 11,000 escalator-related injuries occurred in the year 2007 alone. Of these, approximately 10 percent are believed to have occurred when hands, feet, or shoes became trapped in escalators. Entrapment of hands, feet, and shoes is especially common in the gaps between the escalator steps and the sides of the escalator.

### SUMMARY OF THE INVENTION

The present invention addresses safety concerns on escalators and moving walkways. While conventional escalator skirt brushes signal that a rider is getting too close to the edge of an escalator step by causing a tactile sensation, brushes alone may not be felt by those wearing thick clothing or shoes.

In a first preferred form, the present invention relates to a lighting system for attachment to an escalator skirt, and includes an elongate body adapted to be mounted to an escalator skirt, the elongate body having a backside portion for mounting adjacent to the escalator skirt and further having an inner side portion positioned and facing generally opposite the backside portion. Preferably, two or more elongate groves extend longitudinally along a substantial length of the elongate body and an elongate brush is secured in one of the elongate grooves of the elongate body. Preferably, an elongate rope light secured in the other elongate groove.

Optionally, the elongate body comprises extruded aluminum.

Also optionally, the elongate brush is secured in an upper groove of the two or more elongate groves and the elongate rope light is secured in a lower groove of the two or more elongate grooves. In another optional form, the elongate brush is secured in a lower groove of the two or more elongate grooves and the elongate rope light is secured in an upper groove of the two or more elongate grooves.

In a second preferred form, the present invention relates to a lighting system for attachment to a human conveyor having a pair of side skirts and a moving pathway mounted between the side skirts for convening humans. The lighting system includes an elongate body adapted to be mounted to a side skirt of the human conveyor, with the elongate body having a backside portion for mounting adjacent to the side skirt and further having an inner side portion positioned and facing generally opposite the backside portion. Two or more elongate groves extend longitudinally along a substantial length of the elongate body. An elongate brush is secured in one of the elongate grooves of the elongate body, the elongate brush having bristles extending away from the elongate body. An elongate rope light is secured in the other elongate groove.

Optionally, the human conveyor is an escalator. In another optional form, the human conveyor is a moving sidewalk.

Also optionally, the elongate brush is secured in an upper groove of the two or more elongate groves and the elongate rope light is secured in a lower groove of the two or more elongate grooves. Also optionally, the elongate brush is secured in a lower groove of the two or more elongate grooves and the elongate rope light is secured in an upper groove of the two or more elongate grooves.

The novel lighting system of the present invention provides light in addition to the tactile sensation of brushes, greatly increasing the chance that the rider will notice the proximity of the step's edge and move away from the gap between the step and the side of the escalator. Enhancing visibility may be especially important in poorly-lit areas or at night for outdoor escalators. In addition to keeping riders a safe distance from the edge of an escalator, the lighting system may also help prevent foreign objects from being dropped in the gap at the edge of the escalator steps. The novel lighting system also provides a visually pleasing appearance.

The lighting system uses available space on the escalator skirt and can be installed on new escalators or retrofitted on existing units. Costs are minimized since current equipment does not need to be replaced in order to install the lighting system. In addition to enhancing visibility, the lighting system can be used for decorative purposes. Lighting colors can be changed seasonally or for holidays. Further, for movable walkways and escalators that are able to reverse their directionality, lighting color and/or blinking can be used as indicators of the current direction of movement.

By utilizing this invention, facilities managers at locations and venues employing escalators and moving walkways can increase rider safety and decrease accidents and system downtime due to dropped and/or stuck objects.

### BRIEF DESCRIPTION OF THE DRAWING FIGURES

FIG. 1 is a perspective view of a prior art escalator.

FIG. 2 is a detailed, perspective view of a portion of a prior art escalator, showing a skirt brush installed on the side skirt adjacent the edge of the treads.

FIG. 3 is a perspective, partially exploded view of a lighting system in conjunction with a moving sidewalk, according to a first preferred form of the present invention.

FIG. 3A is a schematic front elevation view of the lighting system of FIG. 3.

FIG. 4 is a perspective, partially exploded view of a lighting system in conjunction with an escalator, according to a second preferred form of the present invention.

FIG. 4A is a schematic front elevation view of the lighting system of FIG. 4.

FIG. 5 is a schematic cross-sectional view of a lighting system according to a preferred form of the present invention for use with escalators and moving sidewalks, wherein an elongate body or housing has an upper groove and a lower groove and wherein the upper groove holds an elongate brush and the lower groove holds an elongate rope light.

FIG. 6 is a schematic cross-sectional view of a lighting system according to another preferred form of the present invention for use with escalators and moving sidewalks, wherein an elongate body or housing has an upper groove and a lower groove and wherein the upper groove holds an elongate rope light and the lower groove holds an elongate brush.

FIG. 7 is a schematic perspective view of the elongate body or housing of FIG. 5 and FIG. 6.

### DETAILED DESCRIPTION

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “on” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

The invention can be implemented in various ways, including as a lighting system for attachment to an escalator skirt. But those skilled in the art will appreciate that the invention is not to be limited to attachment to escalators. For example, the invention can be implemented as a lighting system for a flat or inclined moving walkway.

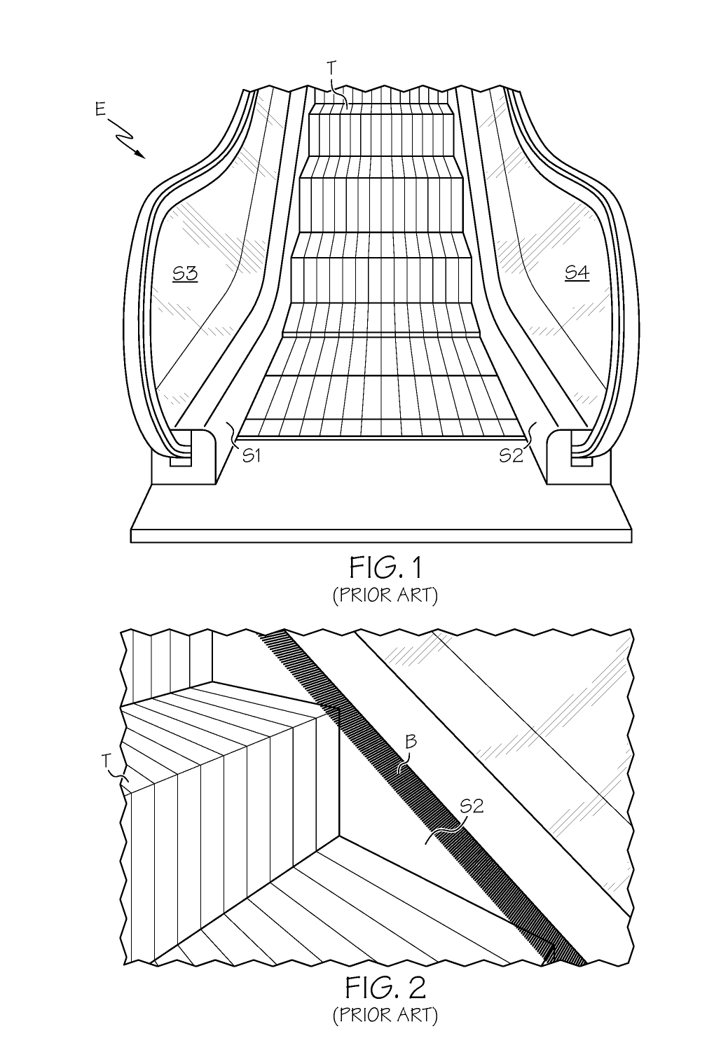

With reference now to the drawing figures, wherein like reference numbers represent corresponding parts throughout the several views, FIG. 1 depicts a prior art escalator, without any brushes or lights installed at or on the side skirts. In this figure, the side skirts S1 and S2 flank the moving treads T of the escalator E, just below the side panels S3, S4.

FIG. 2 is a detailed, perspective view of a portion of a prior art escalator similar to that of FIG. 1, but showing a skirt brush B installed on the side skirt S2 adjacent the edge of the treads T.

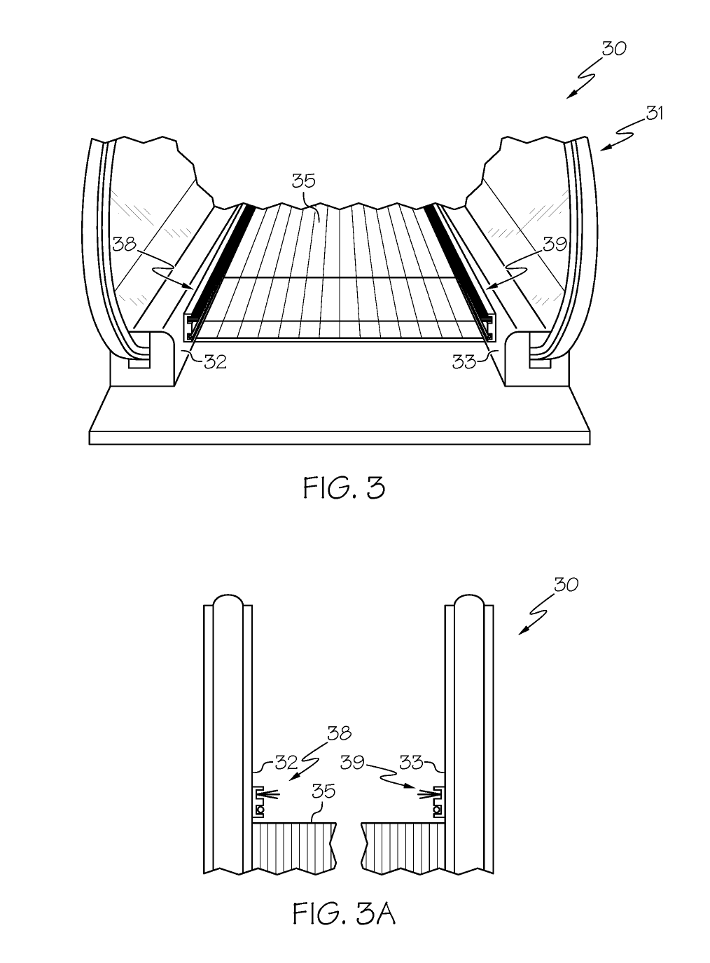

FIG. 3 is a perspective, partially exploded view of a lighting system 30 shown in conjunction with a moving sidewalk 31, according to a first preferred form of the present invention. As shown in this figure, the moving sidewalk includes a pair of side skirts 32, 33 and a moving walkway 35 positioned between the side skirts. Two elongate light assemblies 38, 39 are mounted to the side skirts 32, 33 respectively (in the figure, the light assemblies are shown exploded from and above the side skirts, for clarity of illustration). As depicted in more detail in FIG. 5, the light assemblies 38, 39 include an elongate body or housing, an elongate rope light secured or captured within the elongate body and an optional elongate brush. As seen in FIG. 3A, the light assemblies are positioned on the side skirts 32, 33 below the side panels and closely adjacent the edges of the moving walkway 35.

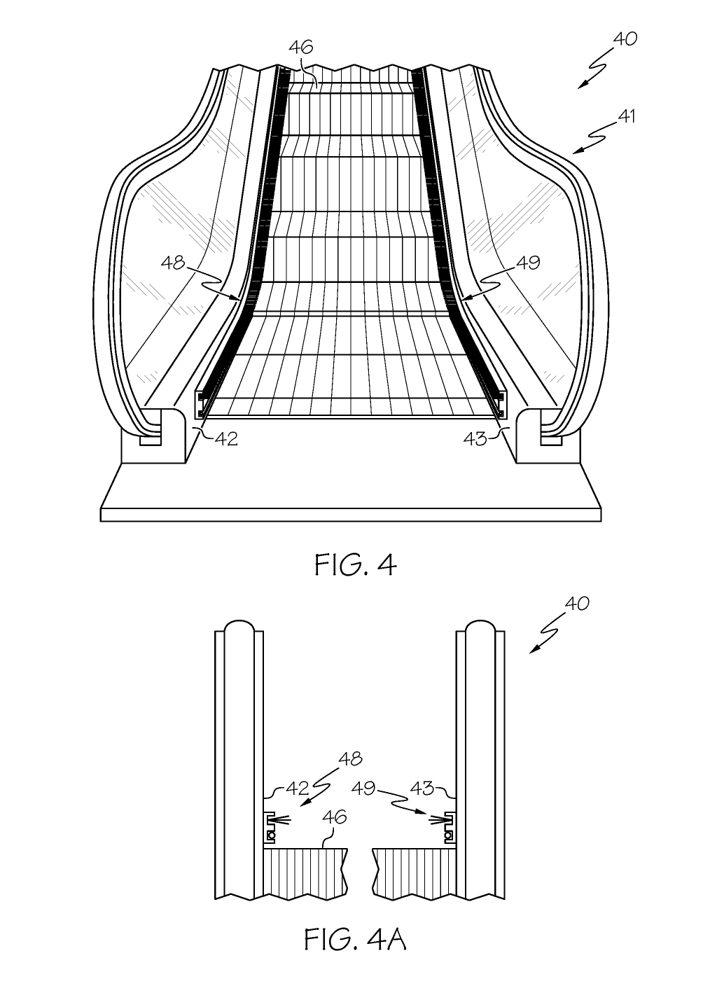

FIG. 4 is a perspective, partially exploded view of a lighting system in conjunction with an escalator, according to a second preferred form of the present invention. As shown herein, a lighting system 40 in conjunction with an escalator 41 includes a pair of side skirts 42, 43 and a moving tread walkway 45 positioned between the side skirts (the moving tread walkway including multiple moving treads, such as tread 46, moving together). Two elongate light assemblies 48, 49 are mounted to the side skirts 42, 43 respectively (in the figure, the light assemblies are shown exploded from and above the side skirts, for clarity of illustration). As depicted in more detail in FIG. 5, the light assemblies 48, 49 include an elongate body or housing, an elongate rope light secured or captured within the elongate body and an optional elongate brush. As seen in FIG. 4A, the light assemblies are positioned on the side skirts 42, 43 below the side panels and closely adjacent the edges of the treads 46.

FIG. 5 is a schematic cross-sectional view of a lighting system 50 according to a preferred form of the present invention for use with escalators and moving sidewalks, wherein an elongate body or housing 51 has an upper groove 52 and a lower groove 53 and wherein the upper groove 52 holds an optional elongate brush 56 and the lower groove holds an elongate rope light 57. The elongate housing 51 includes a back side 51a, L-shaped outer arms or ribs 51b, 51c, and a T-shaped center rib or arm 51d. Thus, the upper groove or channel 52 is defined by the outer arm 51b and the center arm 51d, while the lower groove or channel 53 is defined by the outer arm 51c and the center arm 51d.

The optional elongate brush 56 can be of conventional designs, as are well known to those skilled in the art. The elongate rope light 57 preferably is substantially as large as the groove so as to fill substantially the entire groove and keep foreign objects from becoming lodged in the elongate body or housing. In one example, the rope light is about ⅜″ in diameter with LED elements spaced 1″ apart from adjacent ones another within the rope light. Preferably, the rope light is made of a pliable polymer to facilitate installation of the rope light in the elongate body. Also, preferably, the rope light is transparent or translucent, the tinting of which can be as desired. Likewise, different color LED emitters can be used, as desired. Preferably, the LED rope light is a low-voltage DC unit, to comply with elevator/escalator code and is compliant with ANSI A17.1. Those skilled in the art will recognize that other designs or configurations of elongate lights can be employed as desired.

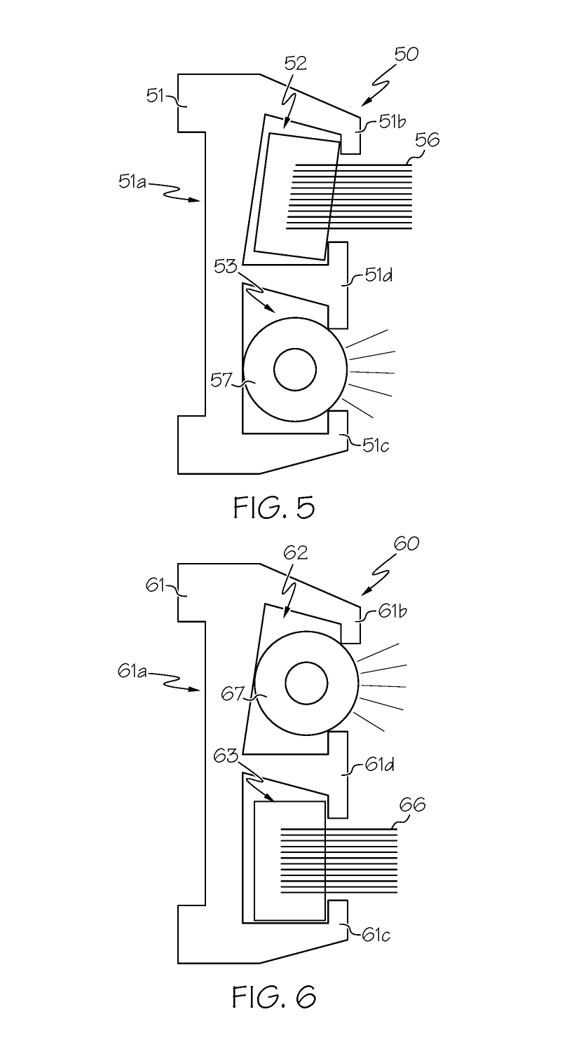

FIG. 6 is a schematic cross-sectional view of a lighting system according to another preferred form of the present invention for use with escalators and moving sidewalks, wherein an elongate body or housing has an upper groove and a lower groove and wherein the upper groove holds an elongate rope light and the lower groove holds an elongate brush. The lighting system 60 includes an elongate body or housing 61 having an upper groove 62 and a lower groove 63 and wherein the lower groove 63 holds an optional elongate brush 66 and the upper groove 62 holds an elongate rope light 67. The elongate housing 61 has a similar construction to that of the housing 51 of FIG. 5, and includes a back side 61a, L-shaped outer arms or ribs 61b, 61c, and a T-shaped center rib or arm 61d. Thus, the upper groove or channel 62 is defined by the outer arm 61b and the center arm 61d, while the lower groove or channel 63 is defined by the outer arm 61c and the center arm 61d.

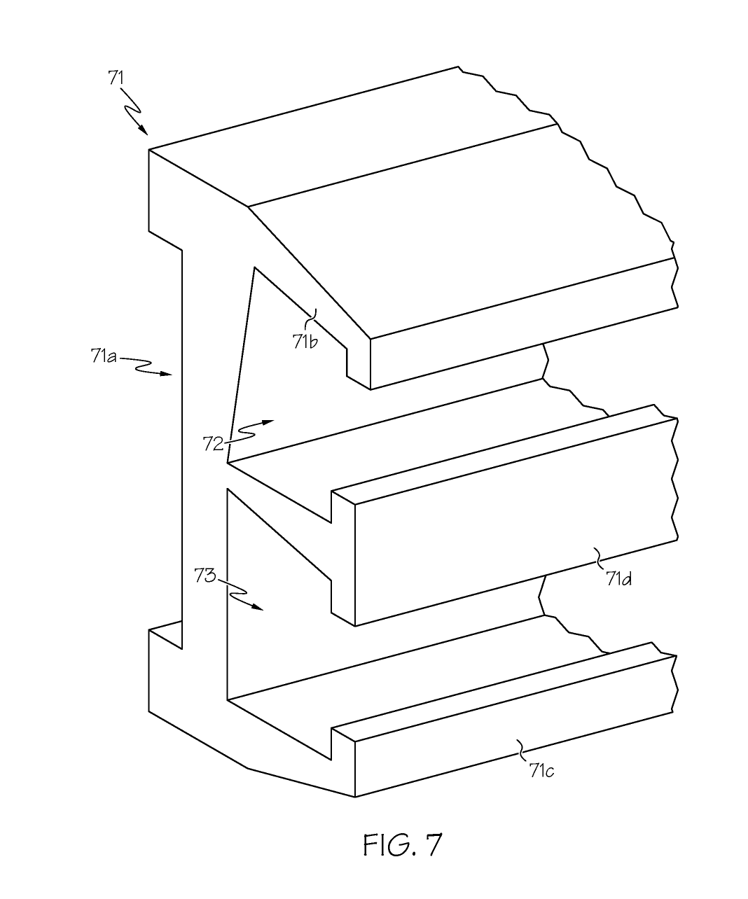

FIG. 7 is a schematic perspective view of an elongate body or housing, such as that shown in FIG. 5 and FIG. 6. The elongate body or housing 71 has an upper groove 72 and a lower groove 73. The elongate housing 71 has a similar construction to that of the housings 51, 61 of FIG. 5 and FIG. 6, and includes a back side 71a, L-shaped outer arms or ribs 71b, 71c, and a T-shaped center rib or arm 71d. Thus, the upper groove or channel 72 is defined by the outer arm 71b and the center arm 71d, while the lower groove or channel 73 is defined by the outer arm 71c and the center arm 71d.

Preferably, a housing is provided with two grooves, one holding a rope light and one holding an elongate brush. Optionally, more grooves can be provided, such as three grooves to provide two rope lights and one brush, two brushes and one rope light, three rope lights, etc. Two rope lights can be positioned to straddle the brush, two brushes could be positioned over or under the rope light, etc. Moreover, a single groove housing can be provided for holding the rope light (dispensing with the optional brush). A wide variety of configurations can be employed, as desired.

The elongate body or housing of the various figures is configured and adapted to include a backside portion adapted for mounting to an escalator skirt or moving sidewalk skirt. Preferably, this elongate body is an aluminum extrusion. The aluminum extrusion can be substantially straight or can be curved in places to follow the contour of the escalator or for other effects.

While the invention has been shown and described in exemplary forms, it will be apparent to those skilled in the art that many modifications, additions, and deletions can be made therein without departing from the spirit and scope of the invention as defined by the following claims.

What is claimed is:

1. A lighting system for attachment to an escalator skirt, the lighting system comprising:
an elongate body adapted to be mounted to an escalator skirt, the elongate body having a backside portion for mounting adjacent to the escalator skirt and further having an inner side portion positioned and facing generally opposite the backside portion, and wherein two or more elongate groves extend longitudinally along a substantial length of the elongate body;
an elongate brush secured in one of the elongate grooves of the elongate body, the elongate brush having bristles extending away from the elongate body; and
an elongate rope light secured in the other elongate groove.

2. The lighting system as claimed in claim 1, wherein the elongate body comprises extruded aluminum.

3. The lighting system as claimed in claim 1, wherein the elongate brush is secured in an upper groove of the two or more elongate groves and the elongate rope light is secured in a lower groove of the two or more elongate grooves.

4. The lighting system as claimed in claim 1, wherein the elongate brush is secured in a lower groove of the two or more elongate grooves and the elongate rope light is secured in an upper groove of the two or more elongate grooves.

5. A lighting system for attachment to a human conveyor having a pair of side skirts and a moving pathway mounted between the side skirts for convening humans, the lighting system comprising:
an elongate body adapted to be mounted to a side skirt of the human conveyor, the elongate body having a backside portion for mounting adjacent to the side skirt and further having an inner side portion positioned and facing generally opposite the backside portion, and wherein two or more elongate groves extend longitudinally along a substantial length of the elongate body;
an elongate brush secured in one of the elongate grooves of the elongate body, the elongate brush having bristles extending away from the elongate body; and
an elongate rope light secured in the other elongate groove.

6. The lighting system as claimed in claim 5, wherein the human conveyor is an escalator.

7. The lighting system as claimed in claim 5, wherein the human conveyor is a moving sidewalk.

8. The lighting system as claimed in claim 5, wherein the elongate brush is secured in an upper groove of the two or more elongate groves and the elongate rope light is secured in a lower groove of the two or more elongate grooves.

9. The lighting system as claimed in claim 5, wherein the elongate brush is secured in a lower groove of the two or more elongate grooves and the elongate rope light is secured in an upper groove of the two or more elongate grooves.
